(19) United States
(12) Patent Application Publication
(10) Pub. No.: US 2026/0280737 A1
(43) Pub. Date: Sep. 17, 2026

(54) METHOD AND APPARATUS FOR CHANNEL INFORMATION FEEDBACK WITH WHITENING INFORMATION IN MOBILE COMMUNICATIONS

(71) Applicant: MEDIATEK INC., Hsinchu City (TW)

(72) Inventors: Chia-Hao YU, Hsinchu City (TW); Jiaxian PAN, Hsinchu City (TW); Jiann-Ching GUEY, Hsinchu City (TW); Parisa CHERAGHI, San Jose, CA (US); Tzu-Han CHOU, San Jose, CA (US); Lung-Sheng TSAI, Hsinchu City (TW)

(21) Appl. No.: 19/471,436

(22) PCT Filed: Aug. 15, 2024
(86) PCT No.: PCT/CN2024/112323

§ 371 Date: Oct. 1, 2025

Related U.S. Application Data
(60) Provisional application No. 63/580,398, filed on Sep. 4, 2023.

(51) Int. Cl. H04B 17/309; H04B 7/0456; H04B 7/06; H04B 17/345

(52) U.S. Cl. CPC H04B 17/346; H04B 7/0456; H04B 7/0626; H04B 17/345

(57) ABSTRACT

Various solutions for channel information feedback with whitening information with respect to user equipment and network apparatus in mobile communications are described. An apparatus may measure a reference signal (RS) from a network node to derive a channel information. The apparatus may determine an interference and noise information observed at a receiver of the apparatus. The apparatus may determine a whitening information based on the interference and noise information. The apparatus may report the whitening information and the channel information to the network node.

### CROSS REFERENCE TO RELATED PATENT APPLICATION(S)

The present disclosure claims the priority benefit of U.S. Provisional Patent Application No. 63/580,398, filed on 4 Sep. 2023, the content of which herein being incorporated by reference in its entirety.

### TECHNICAL FIELD

The present disclosure is generally related to mobile communications and, more particularly, to channel information feedback with whitening information with respect to user equipment (UE) and network apparatus in mobile communications.

### BACKGROUND

Unless otherwise indicated herein, approaches described in this section are not prior art to the claims listed below and are not admitted as prior art by inclusion in this section.

Channel State Information Reference Signal (CSI-RS) is a reference signal (RS) that is used in the downlink (DL) direction in 5G NR, for the purpose of channel sounding and used to measure the characteristics of a radio channel so that it can use proper modulation, code rate, precoder, beam forming etc. UEs will use these reference signals to measure the quality of the DL channel and report this in the uplink (UL) through the CSI reports. The network node sends CSI-RSs for measuring channel status information such as CSI-Reference Signal Receiving Power (RSRP), CSI-Reference Signal Receiving Quality (RSRQ) and CSI-Signal to Interference plus Noise Ratio (SINR) for mobility procedures. Specific instances of CSI-RSs can be configured for time/frequency tracking and mobility measurements. CSI feedback is the way of indicating certain reports by the UE to the network for indicating channel parameters for, e.g., dynamic scheduling purpose. CSI parameters are the quantities related to the state of a channel. The UE reports CSI parameters to the network node (e.g., gNB) as feedback. The CSI feedback includes several parameters, such as the Channel Quality Indicator (CQI), the Precoding Matrix Indicator (PMI) with different codebook sets and the Rank Indicator (RI). The CSI feedback may also include parameters for indicating a CSI-RS resource (or CSI-RS resource set) based on which the CQI, PMI and RI are derived and reported. The UE uses the CSI-RS to measure the CSI feedback. Upon receiving the CSI parameters, the network node can schedule downlink data transmissions (e.g., modulation scheme, code rate, number of transmission layers and MIMO precoding) accordingly.

In current NR CSI framework, the UE feeds back the UE preferred precoders for CSI feedback. Current CSI report considers a single transmission/reception point (TRP)-UE signal channel. Each UE reports a preferred precoder observed by the UE. The reported precoder may not reflect real channel status and does not consider noise information and/or the interference from transmissions for other UEs. This may be suitable for Single-User Multiple-Input Multiple-Output (SU-MIMO) scenarios where inter-user interference is not a major concern. However, this is not a preferred solution for Multiple-User Multiple-Input Multiple-Output (MU-MIMO) scenarios. The network node cannot determine proper precoders and modulation and coding scheme (MCS) and thus is not able to manage the noise and interferences among multiple UEs. Although the network node may perform some processes to make the signals more orthogonal among different UEs. But such processes may cause signal power loss and may degrade the signal performance.

Accordingly, how to feedback real/proper channel information and noise/interference information for channel and interference management becomes an important issue in the newly developed wireless communication network. Therefore, there is a need to provide proper schemes to perform CSI measurement and reporting.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to channel information feedback with whitening information with respect to user equipment and network apparatus in mobile communications.

In one aspect, a method may involve an apparatus measuring a reference signal from a network node to derive a channel information. The method may also involve the apparatus determining an interference and noise information observed at a receiver of the apparatus. The method may further involve the apparatus determining a whitening information based on the interference and noise information. The method may further involve the apparatus reporting the whitening information and the channel information to the network node.

In one aspect, a method may involve a network node transmitting a reference signal to a UE. The method may also involve the network node receiving a whitening information and a channel information from the UE. The method may further involve the network node determining at least one of a precoder and a modulation and coding scheme according to the whitening information and the channel information. The method may further involve the network node performing a downlink transmission to the UE by using the at least one of the precoder and the modulation and coding scheme.

In one aspect, an apparatus may comprise a transceiver which, during operation, wirelessly communicates with at least one network node of a network side. The apparatus may also comprise a processor communicatively coupled to the transceiver. The processor, during operation, may perform operations comprising measuring, via the transceiver, a reference signal from a network node to derive a channel information. The processor may also perform operations comprising determining an interference and noise information observed at a receiver of the apparatus. The processor may further perform operations comprising determining a whitening information based on the interference and noise information. The processor may further perform operations comprising reporting, via the transceiver, the whitening information and the channel information to the network node.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting example scenarios under schemes in accordance with implementations of the present disclosure.

FIG. 4 is a diagram depicting an example scenario under schemes in accordance with implementations of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to channel information feedback with whitening information with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

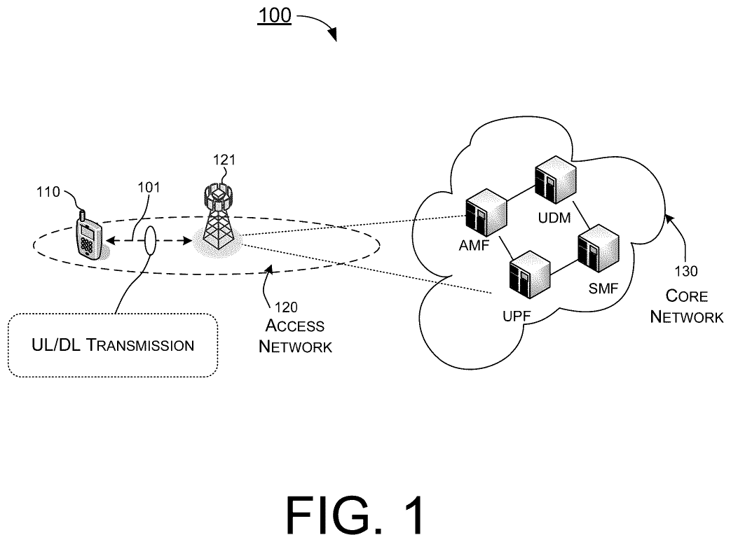

FIG. 1 illustrates an exemplary 5G NR network supporting CSI compression based on multi-dimensional MIMO radio frequency (RF) signature in accordance with embodiments of the present disclosure. The 5G NR network 100 includes a user equipment (UE) 110 communicatively connected to a gNB 121 of an access network 120 which provides radio access using a Radio Access Technology (RAT) (e.g., the 5G NR technology). The access network 120 is connected to a 5G core network 130 by means of the Next Generation (NG) interface, more specifically to a User Plane Function (UPF) by means of the NG user-plane part (NG-u), and to an Access and Mobility Management Function (AMF) by means of the NG control-plane part (NG-c). One gNB can be connected to multiple UPFs/AMFs for the purpose of load sharing and redundancy. The UE 110 may be a smart phone, a wearable device, an Internet of Things (IoT) device, and a tablet, etc. Alternatively, UE 110 may be a Notebook (NB) or a Personal Computer (PC) inserted or installed with a data card which includes a modem and RF transceiver(s) to provide the functionality of wireless communication.

The gNB 121 may provide communication coverage for a geographic coverage area in which communications with the UE 110 is supported via a communication link 101. The communication link 101 shown in the 5G NR network 100 may include uplink (UL) transmissions from the UE 110 to the gNB 121 (e.g., on the Physical Uplink Control Channel (PUCCH) or Physical Uplink Shared Channel (PUSCH)) or downlink (DL) transmissions from the gNB 121 to the UE 110 (e.g., on the Physical Downlink Control Channel (PDCCH) or Physical Downlink Shared Channel (PDSCH)).

In one novel aspect, the UE may estimate a multi-dimensional non-orthogonal basis at a receiver based on a set of reference signals (RSs) transmitted by a transmitter(s) and feeds back the multi-dimensional non-orthogonal basis (e.g. N-dimensional sinusoidal matrix) in a first periodicity; and estimates a linear combination coefficients of the multi-dimensional non-orthogonal basis based on the set of reference signals and feeds back the linear combination coefficients in a second periodicity. Specifically, the UE may receive reference signals, such as the CSI-RS. The UE may obtain feedback configurations (e.g., CSI report configurations). In one embodiment, the feedback configuration is predefined. In another embodiment, the feedback configuration is dynamically updated. The UE may estimate the basis matrix and the coefficient matrix. Further, the UE may compress the basis matrix and the coefficient matrix as a compressed feedback. Then, the UE transmits the compressed feedback to the network. While the multi-dimensional basis is in general non-orthogonal, in some embodiments, orthogonal basis is used as approximation.

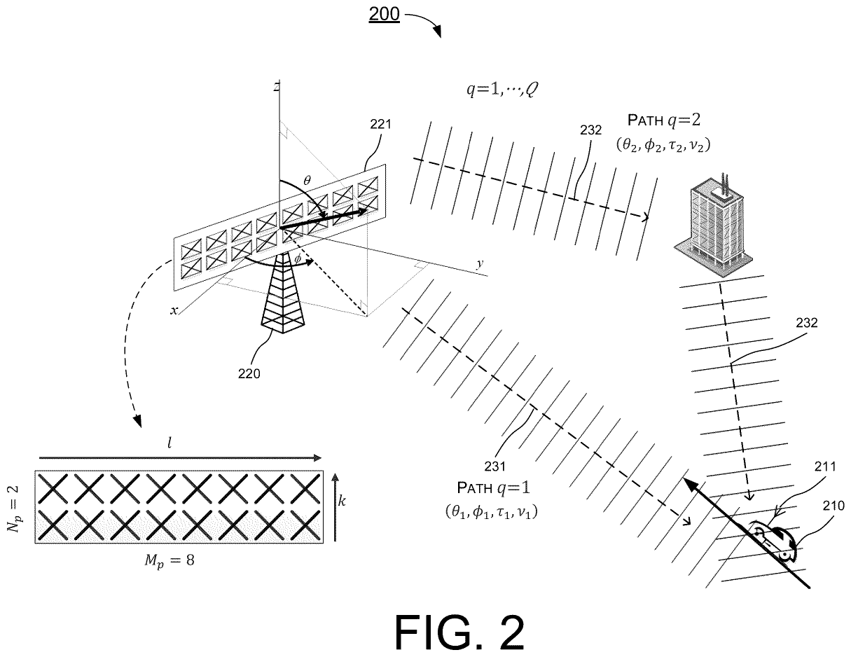

FIG. 2 illustrates exemplary diagrams of a geometrical model for multi-dimensional MIMO channel and CSI feedback with a basis matrix and a coefficient matrix in accordance with embodiments of the present disclosure. A UE 210 with MIMO transceiver/antennas 211 may establish RF link with gNB 220 with transceiver/antenna array 221. There are multiple, 1 to Q, transceiving paths for the link between UE 210 and gNB 222. Each path may be defined by an elevation angle θ, an azimuth angle Ø, a delay τ, and a doppler v. The elevation angle θ and the azimuth angle Ø may further be scaled to be a real value between 0 and 1. An exemplary illustration of a first path (e.g., q=1) 231, which is a line-of-sight path, and a second path (e.g., q=2) 232, which is a non-line-of-sight path, are shown in FIG. 2. The channel between the gNB antenna array 221 and one receive (RX) antenna i of UE antennas 211 may be determined by the number of paths Q, the parameter ω_{q}=[θ_{q}Ø_{q}τ_{q} c_{q}]^{T} for each path q, and the complex channel gain λ_{iq}. The multi-path channel with number of Q paths may be modelled as matrix Ω, where

$$Ω = [ \begin{matrix}{θ}_{1} & ⋯ & {θ}_{Q} \\ {ϕ}_{1} & ⋯ & {ϕ}_{Q} \\ {τ}_{1} & ⋯ & {τ}_{Q} \\ {v}_{1} & ⋯ & {v}_{Q}\end{matrix} ] = [ \begin{matrix}{ω}_{1} & ⋯ & {ω}_{Q}\end{matrix} ] .$$

The transmit (TX) antenna may comprise an antenna array. The number of TX antenna n_{T} may be determined by a number of elements in elevation Nₚ a number of elements in azimuth Mₚ, and a number of polarizations Nₚₒₗ. For example, assuming that Nₚ=2, Mₚ=8 and Nₚₒₗ=2, the total number of antennas may be n_{T}=MₚNₚNₚₒₗ=32. To indicate the position of individual antennas, defining index k(j) and l(j), for j=0, 1, . . . , n_{T}−1 where k(j)=└j/Mₚ┘−Nₚ└j/(MₚNₚ)┘ and l(j)=mod(j,Mₚ), may be used to indicate the antenna position in vertical and horizontal plane, respectively, for antenna j.

In one exemplary scenario, gNB 220 may transmit at least one CSI-RS to UE 210. UE 210 may receive the at least one CSI-RS from gNB 220. UE 210 may estimate at least one covariance matrix of at least one downlink channel matrix and/or at least one downlink channel matrix according to the at least one CSI-RS at different times n and frequencies m. Specifically, after receiving the CSI-RSs at different times and frequencies, the UE 110 may estimate the downlink channel matrices H[n, m] of n_{R}×n_{T} MIMO channels as below:

$$H [ n , m ] = [ \begin{matrix}{h}_{11} [ n , m ] & ⋯ & {h}_{1 {n}_{T}} [ n , m ] \\ ⋮ & ⋱ & ⋮ \\ {h}_{{n}_{R} 1} [ n , m ] & ⋯ & {h}_{{n}_{R} {n}_{T}} [ n , m ]\end{matrix} ]$$

n_{R} denotes the number of receiving antennas (i.e., antennas 211). n_{T} denotes the number of transmitting antennas (i.e., antennas 221). n denotes time domain index. m denotes frequency domain index. Assuming the complex channel gain for the RX antenna i of the path q is λ_{iq}, the downlink channel matrix of the RX antenna i of the path q may be modelled as below:

$${h}_{ij} [ n , m ] = \text{?}$$

which can be represented as:

$${h}_{ij} [ n , m ] = {\sum }_{q = 1}^{Q} {λ}_{iq} {γ}_{qj} [ n , m ]$$

wherein γ_{qj} [symbol] ^{2πnv}^{_{q}}= [symbol] ^{2π[-k(j) l(j) -m n]ω}^{_{q}}, and ω_{q}=[θ_{q}Ø_{q}τ_{q}v_{q}]^{T}. The index k(j) and l(j), for j=1, 2, . . . , n_{T} is used to translate the antenna index into antenna position for antenna j. For a planer antenna array, the indexing can be similar to FIG. 2.

In one novel aspect, the channel matrices H[n, m] may be modelled as a linear combination of multi-dimensional complex sinusoids. In one embodiment, the time-frequency MIMO channel may be modeled as a linear combination of a 4-dimentional (4-D) basis represented as:

$$H [ n , m ] = Λ {Γ}_{Ω} [ n , m ]$$

Λ denotes the complex linear combination matrix of dimension n_{R}×Q:

$$Λ = [ \begin{matrix}{λ}_{11} & ⋯ & {λ}_{1 Q} \\ ⋮ & ⋱ & ⋮ \\ {λ}_{{n}_{R} 1} & ⋯ & {λ}_{{n}_{R} Q}\end{matrix} ]$$

and the 4-D sinusoidal basis Γ_{Ω} with dimension of Q×n_{T} may be represented as:

$${Γ}_{Ω} [ n , m ] = [ \begin{matrix}{γ}_{11} [ n , m ] & ⋯ & {γ}_{1 {n}_{T}} [ n , m ] \\ ⋮ & ⋱ & ⋮ \\ {γ}_{Q 1} [ n , m ] & ⋯ & {γ}_{{Qn}_{T}} [ n , m ]\end{matrix} ]$$

where Λ and Ω may be constants or slow-varying.

In one novel aspect, CSI feedback may be sent to the network based on the estimation of the multi-dimensional non-orthogonal basis matrix Γ_{Ω} and the linear combination coefficient matrix Λ. The feedback of the basis matrix may be accomplished by feeding back matrix Ω. The basis matrix Λ_{Ω} can be reconstructed based on the formulation above accordingly. The basis matrix is parameterized by a group of 4-dimensional parameter sets. The feeding back of the basis matrix is accomplished by feeding back the group of 4-dimensional parameter sets. In one embodiment, the CSI estimation matrices may be compressed before sending the feedback. In one embodiment, periodicity may be configured for the compressed feedback CSI matrices.

In some implementations, one or more elements (λ_{iq}) of the coefficient matrix Λ may be removed based on one or more coefficient compressing criteria. In one embodiment, the one or more coefficient compressing criteria may comprise removing element(s) with value smaller than a predefined threshold, and/or selecting a predefined number of elements, and/or selecting a predefined percentage number of elements. In one example, if an element λ_{iq} is “small” compared with other elements, it may be ignored from feedback. In one embodiment, the determination of “small” is by comparing the element with a threshold. The threshold may be predefined or derived based on all or a subset of element values in Λ. In another embodiment, the determination of “small” is by sorting. In one example, a fixed number of elements with biggest values are selected. The value of the fixed number can be predefined or dynamically configured or derived. In another example, a fixed ratio among all elements is selected. The value of the fixed ratio may be predefined or dynamically configured or derived.

In some implementations, one or more path columns (λ_{1Q} . . . λₙ_{_{R}}_{Q}) may be removed based on one or more path-based compression criteria. One or more elements of the coefficient matrix may be removed based on all values across all receiving antennas for each path and one or more paths may be identified to be compressed. In one embodiment, one or more elements of the coefficient matrix may be removed based on all values across all element values in a first dimension denoting a path of the coefficient matrix, and wherein elements in a second dimension of the coefficient matrix may be identified to be compressed. In one embodiment, the path-based compressing criteria may be based on all values across the RX antennas for a fixed path. In one embodiment, one or more values of the path may be compared with a threshold or one or more paths may be selected by sorting. For example, the selection may be based on all values across RX antennas i for a fixed path q, that is, λ′_{iq}s for i=1, . . . n_{R}. In one embodiment, if a path q is determined for not feedback, its associated ω_{q} does not feedback either. The determination of a path q not to be feedback may be based on a function of

$${λ}_{iq}^{′} s$$

for i=1, . . . n_{R}. In one embodiment, the selection of one or more paths for removing may be by comparing the value(s) across the path with a path threshold. In one embodiment, the path threshold may be predefined. In another embodiment, the path threshold may be dynamically configured or derived. In another embodiment, the selection of one or more paths for removing may be by sorting. In one example, a fixed number of paths/columns with biggest values may be selected. The value of the fixed number may be predefined or dynamically configured or derived. In another example, a fixed ratio among all paths/columns may selected. The value of the fixed ratio may be predefined or dynamically configured or derived. It is noted that when path q is needed for feedback, feeding back ω₂ may be enough for deriving its associated sinusoidal basis in Γ_{Ω}.

In one novel aspect, the CSI feedback compression may be implemented in the RX antenna dimension in accordance with embodiments of the present disclosure. The CSI feedback may be compressed by reducing one of the dimensions of the coefficient matrix by compressing a decomposition matrix derived from the coefficient matrix. In some implementations, the CSI feedback may be compressed in the RX antenna dimension by eigenvalue decomposition (EVD) or by singular value decomposition (SVD). The CSI feedback matrix Λ is of dimension n_{R}×Q. If the RX antennas are correlated with each other (e.g., due to proximity), the rank of Λ may be smaller than n_{R}, or at least the number of significant eigenvalues of Λ may be smaller than n_{R}. Therefore, the UE may further compress the CSI feedback from the RX antenna dimension into the smaller rank dimension.

In one embodiment, the compressing may reduce the receiving antenna dimension by eigenvalue decomposition. Λ is of dimension n_{R}×Q. The dimension of RX antenna n_{R} may be reduced to ρ, where ρ≤n_{R}. The product of coefficient matrix Λ and its Hermitian transpose Λ^{H} may be expressed as:

$${Λ}^{H} Λ \approx {\tilde{Λ}}^{H} \sum \tilde{Λ}$$

Σ is a ρ×ρ diagonal matrix with ρ≤n_{R}. \tilde{Λ} is a ρ×Q rank-reduced matrix containing the linear combination coefficients. \tilde{Λ}^{H} with the dimension of Q×ρ is the Hermitian transpose of \tilde{Λ}.

The feedback of Λ may be further compressed by eigenvalue decomposition and to obtain Λ^{H}Λ= [symbol] Σₑ [symbol] (with equality sign). In \tilde{Λ}^{H}Λ≈\tilde{Λ}^{H} Σ\tilde{Λ}, the “≈” may imply that compression has been performed based on the diagonal matrix Σₑ. Then, compression may be performed on Σₑ and associated [symbol] . In one embodiment, eigenvalue decomposition may facilitate removing one or [symbol] more elements of a diagonal matrix for the coefficient matrix along with corresponding eigenvalues based on one or more criteria comprising removing elements smaller than a predefined threshold, selecting a predefined number of elements, and selecting a predefined percentage number of elements. In one embodiment for compressing, the values of Σₑ less than a threshold may be ignored/removed from feedback, so does their associated eigenvectors in [symbol] . In one embodiment, the threshold may [symbol] be predefined. In another embodiment, the threshold may be dynamically configured or derived. In another embodiment for compressing, a fixed number of eigenvalues may be fed back along with their associated eigenvectors in [symbol] . Others may be ignored/removed from feedback. In one embodiment, the value of the fixed number may be predefined. In another embodiment, the value of the fixed number may be dynamically configured or derived. In yet another embodiment for compressing, a fixed ratio among all eigenvalues may be fed back along with their associated eigenvectors in [symbol] . Others may be ignored/removed from feedback. In one embodiment, the value of the fixed ratio may be predefined. In another embodiment, the value of the fixed ratio may be dynamically configured or derived. In other embodiments for compressing, only eigenvectors associated with the selected feedback eigenvalues may be fed back while eigenvectors associated with eigenvalues that are not selected may be removed from feedback. After compressing, compressed \tilde{Λ} and Σ may be sent as the CSI feedback. Alternatively, only \tilde{Λ} may be sent as the CSI feedback for additional overhead reduction. In one embodiment, the feedback coefficient matrix may be derived by projecting the coefficient matrix on the at least one eigenvector matrix.

In one embodiment, the compressing may reduce CSI feedback in receiving antenna dimension by SVD. Λ is of dimension n_{R}×Q. The dimension of RX antenna n_{R} may be reduced to ρ, where ρ≤n_{R}. The coefficient matrix Λ may be expressed as:

$$Λ \approx U \sum {V}^{H}$$

Σ is a ρ×ρ diagonal matrix with ρ≤n_{R}, ρ<Q. U is a n_{R}×ρ rank-reduced matrix containing left eigen vector. V is a Q×ρ rank-reduced matrix containing right eigen vector. V^{H} with the dimension of ρ×Q is the Hermitian transpose of V.

The feedback of Λ may be further compressed by SVD and to obtain

$$Λ = {U}_{s} {\sum }_{s} {V}_{s}^{H}$$

(with equality sign). In Λ≈UΣV^{H}, the “≈” may imply that compression has been performed based on the diagonal matrix Σₛ. Then, compression may be performed on Σₛ, and its associated V. In one embodiment, SVD may facilitate removing one or more elements of a diagonal matrix for the coefficient matrix along with corresponding V based on one or more criteria comprising removing elements smaller than a predefined threshold, selecting a predefined number of elements, and selecting a predefined percentage number of elements. In one embodiment for compressing, the values of Σₛ less than a threshold may be ignored/removed from feedback, so does their associated eigenvectors in V. In one embodiment, the threshold may be predefined. In another embodiment, the threshold may be dynamically configured or derived. In another embodiment for compressing, a fixed number of eigenvalues may be fed back along with their associated eigenvectors in V. Others may be ignored/removed from feedback. In one embodiment, the value of the fixed number may be predefined. In another embodiment, the value of the fixed number may be dynamically configured or derived. In yet another embodiment for compressing, a fixed ratio among all eigenvalues may be fed back along with their associated eigenvectors in V. Others may be ignored/removed from feedback. In one embodiment, the value of the fixed ratio may be predefined. In another embodiment, the value of the fixed ratio may be dynamically configured or derived. In other embodiments for compressing, only eigenvectors associated with the selected feedback eigenvalues may be fed back. Selected non-feedback eigenvalues may be removed. After compressing, compressed V and Σ may be sent as CSI feedback. Alternatively, only V may be sent as CSI feedback for additional overhead reduction.

It should be noted that since H[n, m]=ΛΓ_{Ω}[n, m] in the formulation,

$$\tilde{H} [ n , m ] \text{?} {U}_{s}^{H} H [ n , m ] = {U}_{s}^{H} Λ {Γ}_{Ω} [ n , m ] = {U}_{s}^{H} ( {U}_{s} {\sum }_{s} {V}_{s}^{H} ) {Γ}_{Ω} [ n , m ] = {\sum }_{s} {V}_{s}^{H} {Γ}_{Ω} [ n , m ] \text{?} \hat{Λ} {Γ}_{Ω} [ n , m ] ,$$

where Uₛ is the n_{R}×ρ left eigenvector of Λ above and

$$\hat{Λ} \text{?} {\sum }_{s} {V}_{s}^{H} .$$

Compressing (and then reporting) Λ is the same as compressing (and then reporting) \hat{Λ} for reconstructing H[n, m] and \tilde{H}[n, m], respectively. From precoder derivation at network node perspective, H[n, m] and \tilde{H}[n, m] provide similar information, and either compression alternative may be applied.

In some implementations, different options for CSI feedback including the representation, periodicity, and other configurations may be applied in accordance with embodiments of the present disclosure. In one embodiment, one or more feedback options may be configured. In one embodiment, different representations may be configured as different feedback options. The basis matrix may be in a format of 4D (4 dimension), 3D (3 dimension), or 2D (2 dimension). The MIMO channel model H[n, m] may comprise the time domain index n and the frequency domain index m.

In a 4D-basis representation, Ω and Λ may be represented as:

$$Ω = [ \begin{matrix}{θ}_{1} & ⋯ & {θ}_{Q} \\ {ϕ}_{1} & ⋯ & {ϕ}_{Q} \\ {τ}_{1} & ⋯ & {τ}_{Q} \\ {v}_{1} & ⋯ & {v}_{Q}\end{matrix} ] = [ \begin{matrix}{ω}_{1} & ⋯ & {ω}_{Q}\end{matrix} ] ,$$

$$Λ = [ \begin{matrix}{λ}_{11} & ⋯ & {λ}_{1 Q} \\ ⋮ & ⋱ & ⋮ \\ {λ}_{{n}_{R} 1} & ⋯ & {λ}_{{n}_{R} Q}\end{matrix} ]$$

$$and$$

$$H [ n , m ] = Λ {Γ}_{Ω} [ n , m ]$$

where Λ and Ω may be constants or slow-varying.

In a 3D-basis representation, time domain index n may be absorbed into linear combination coefficients λ_{iq}. The downlink channel matrix of the RX antenna i of the path q may be represented as

$${h}_{ij} [ n , m ] = {\sum }_{q = 1}^{Q} {λ}_{iq} [ n ] {γ}_{qj} [ m ]$$

$$where$$

$${λ}_{iq} [ n ] = {λ}_{iq} {e}^{j 2 π {nv}_{d}} = {e}^{j 2 π [ 000 n ] {ω}_{q}}$$

$$and$$

$${\text{?}}^{2 π [ - k ( j ) l ( j ) - m 0 ] {ω}_{q}} .$$

The elevation angle, azimuth angle, delay and Doppler for each path may be represented as:

$${Ω}^{′} = [ \begin{matrix}{θ}_{1} & ⋯ & {θ}_{Q} \\ {ϕ}_{1} & ⋯ & {ϕ}_{Q} \\ {τ}_{1} & ⋯ & {τ}_{Q}\end{matrix} ]$$

$${Ω}^{*} = [ \begin{matrix}{v}_{1} & ⋯ & {v}_{Q}\end{matrix} ]$$

$$Ω = [ \begin{matrix}{Ω}^{′} \\ {Ω}^{*}\end{matrix} ] = [ \begin{matrix}{ω}_{1}^{′} & ⋯ & {ω}_{Q}^{′} \\ {ω}_{1}^{′′} & ⋯ & {ω}_{Q}^{′′}\end{matrix} ] = [ \begin{matrix}{ω}_{1} & ⋯ & {ω}_{Q}\end{matrix} ]$$

The complex linear combination matrix of dimension n_{R}× Q may be represented as:

$$Λ [ n ] = [ \begin{matrix}{λ}_{11} [ n ] & ⋯ & {λ}_{1 Q} [ n ] \\ ⋮ & ⋱ & ⋮ \\ {λ}_{{n}_{R} 1} [ n ] & ⋯ & {λ}_{{n}_{R} Q} [ n ]\end{matrix} ]$$

The 3D non-orthogonal Fourie basis may be represented as:

$${Γ}_{{Ω}^{′}} [ m ] = [ \begin{matrix}{γ}_{11} [ m ] & ⋯ & {γ}_{1 {n}_{T}} [ m ] \\ ⋮ & ⋱ & ⋮ \\ {γ}_{Q 1} [ m ] & ⋯ & {γ}_{{Qn}_{T} [ m ]}\end{matrix} ]$$

The time-frequency MIMO channel as a linear combination of the 3D basis may be represented as:

$$H [ n , m ] = Λ [ n ] {Γ}_{{Ω}^{′}} [ m ]$$

where Ω′ may be constants or slow-varying.

In a 2D-basis representation, time domain index n and frequency domain index m may be both absorbed into linear combination coefficients λ_{iq}. The downlink channel matrix of the RX antenna i of the path q may be represented as

$${h}_{ij} [ n , m ] = {\sum }_{q = 1}^{Q} {λ}_{iq} [ n , m ] {γ}_{qj}$$

$$where$$

$${λ}_{iq} [ n , m ] = {λ}_{iq} {e}^{- j 2 π m τ + 2 π {nv}_{d}} = {e}^{j 2 π [ 00 - m n ] {ω}_{q}}$$

$$and$$

$${\text{?}}^{2 π [ - k ( j ) l ( j ) 00 ] {ω}_{q}} = {e}^{𝒿2π [ - k ( j ) l ( j ) ] {ω}_{q}^{′′}} .$$

The elevation angle, azimuth angle, delay and Doppler for each path may be represented as:

$${Ω}^{′′} = [ \begin{matrix}{θ}_{1} & ⋯ & {θ}_{Q} \\ {ϕ}_{1} & ⋯ & {ϕ}_{Q}\end{matrix} ]$$

$${Ω}^{**} = [ \begin{matrix}{τ}_{1} & ⋯ & {τ}_{Q} \\ {v}_{1} & ⋯ & {v}_{Q}\end{matrix} ]$$

$$Ω = [ \begin{matrix}{Ω}^{′′} \\ {Ω}^{**}\end{matrix} ] = [ \begin{matrix}{ω}_{1}^{′′} & ⋯ & {ω}_{Q}^{′′} \\ {ω}_{1}^{′′′} & ⋯ & {ω}_{Q}^{′′′}\end{matrix} ] = [ \begin{matrix}{ω}_{1} & ⋯ & {ω}_{Q}\end{matrix} ]$$

The complex linear combination matrix of dimension n_{R}×Q may be represented as:

$$Λ [ n , m ] = [ \begin{matrix}{λ}_{11} [ n , m ] & ⋯ & {λ}_{1 Q} [ n , m ] \\ ⋮ & ⋱ & ⋮ \\ {λ}_{{n}_{R} 1} [ n , m ] & ⋯ & {λ}_{{n}_{R} Q} [ n , m ]\end{matrix} ]$$

The 2D non-orthogonal Fourier basis may be represented as:

$${Γ}_{{Ω}^{′′}} = [ \begin{matrix}{γ}_{11} & ⋯ & {γ}_{1 {n}_{T}} \\ ⋮ & ⋱ & ⋮ \\ {γ}_{Q 1} & ⋯ & {γ}_{{Qn}_{T}}\end{matrix} ]$$

The time-frequency MIMO channel as a linear combination of the 2D basis may be represented as:

$$H [ n , m ] = Λ [ n , m ] {Γ}_{{Ω}^{′′}}$$

where Ω″ may be constant or slow-varying.

In some implementations, based on the representation, the feedback periodicity may be configured accordingly. In one embodiment, the parameters for deriving basis matrix may be constant or slow varying, and its associated feedback may be provided in a first periodicity. In one embodiment, the coefficient matrix may not include timing-varying components (that is, without time domain index n), and may be constant or slow varying. The associated feedback for the coefficient matrix may be transmitted in a second periodicity. In one embodiment, the second periodicity may be longer than or equal to the first periodicity. In another embodiment, the coefficient matrix may include time-varying components, and wherein the time-varying coefficient matrix may be transmitted in a third periodicity that is shorter than the first periodicity or shorter than the second periodicity.

For example, Ω, Ω′, Ω″ in 4D/3D/2D basis matrix, respectively, may be constants or slow-varying and may be configured with a first periodicity for feedback. Λ may be constants or slow-varying, and may be configured with a second periodicity for feedback. The second periodicity may be equal to or longer than the first periodicity. Λ[n], Λ[n, m] may be time-varying faster than Λ, Ω, Ω′, Ω″, and may be configured with a third periodicity for feedback. The third periodicity may be shorter than the first periodicity. The third periodicity may be shorter than the second periodicity. It is noted that for CSI feedback purpose, one out of 2D/3D/4D representation may be used (for example by configuration). The compression details and periodicity setting may follow the used representation accordingly as discussed above.

In some implementations, other configurations for feedback are available. In one embodiment, Γ_{Ω}, Γ_{Ω′}, Γ_{Ω″}, may be fed back without accompanying Λ, Λ[n], Λ[n, m]. Only the basis matrix (or the parameters for deriving the basis matrix) may be transmitted as the CSI feedback when the feedback is for acquiring spatial domain channel characteristics, for example, beam direction acquisition. In one embodiment, Γ_{Ω″}, may be fed back for acquiring spatial domain characteristics of the channel for (analog) beam direction acquisition. In one embodiment, no Doppler information may be reported. The information related to v and its index n may not be included in the corresponding 2D/3D/4D representation and accordingly, may not be fed back.

However, the channel information feedback (e.g., H[n, m]) based on 4D/3D/2D forms does not provide noise information (may or may not include interference) observed at the receiver side. In NR CSI feedback, in addition to precoder feedback (e.g., PMI), channel quality indicator (CQI) may be also fed back to indicate what spectral efficiency can be supported based on some hypothesis on rank and/or precoders. Without the noise and/or interference information, the reported feedback may not reflect the real channel status. The precoder and/or modulation and coding scheme determined by the network side may not be optimal without considering the noise and/or interference information. Therefore, there is a need to include noise and/or interference information by the receiver so that the transmitter side can derive modulation and coding scheme for the transmission between the transmitter and the receiver.

In view of the above, the present disclosure proposed several schemes pertaining to channel information feedback with whitening information. The whitening information may reflect the noise and/or interference observed at the receiver side. The whitening information may be reported along with the channel information (e.g., channel parameters) to be fed back. The channel parameters to be fed back may take one of the following alternatives: {Λ, Ω}, {Λ[n], Ω′} {Λ[n, m], Ω″}. In addition, the compression schemes described above may also be applied for feeding back the whitening information and the channel parameters. Accordingly, the receiver side is able to reconstruct the comprehensive channel information/condition based on the reported information and enable interference/noise management capability at the network side.

Specifically, the UE may measure a reference signal from the network node to derive a channel information (e.g., H[n, m]). The UE may determine an interference and noise information observed at a receiver of the UE. The interference and noise information may comprise only an interference information, only a noise information, or both the interference information and the noise information. The interference and noise information may be represented by a covariance matrix. The covariance matrix may comprise at least one of a square matrix representing noise variance at a receiver of the apparatus, a white noise, or a covariance matrix of spatially colored interference plus noise. The UE may determine the covariance matrix by measuring an interference measurement resource (IMR) from the network node. The IMR may comprise at least one of a zero-power (ZP) downlink (DL) RS and a non-zero-power (NZP) DL RS. Then, the UE may determine a whitening information based on the interference and noise information. For example, the UE may determine a pre-whitening matrix (i.e., whitening information) based on the covariance matrix. The pre-whitening matrix may be obtained/determined by the covariance matrix based on a Cholesky factorization or based on an eigenvalue decomposition. The pre-whitening matrix may comprise a pre-whitening filter reflecting at least one spatial direction or layer with lower interference and noise. After determining the whitening information, the UE may report the whitening information and the channel information to the network node. For example, the UE may report a pre-whitened channel information comprising the channel information and the pre-whitening matrix to the network node. Alternatively, the UE may report the channel information and the covariance matrix individually to the network node.

From network's point of view, the network node may transmit a reference signal to the UE. In addition, the network node may transmit an IMR to the UE for measurement. The IMR comprises at least one of a ZP DL RS and an NZP DL RS. The network node may receive a whitening information and a channel information from the UE. The whitening information may comprise only an interference information, only a noise information, or both the interference information and the noise information. The whitening information may be represented by a pre-whitening matrix. For example, the network node may receive a pre-whitened channel information comprising the channel information and the pre-whitening matrix from the UE. Alternatively, the network node may receive the channel information and a covariance matrix individually from the UE. The network node may determine the pre-whitening matrix based on the covariance matrix and determine a pre-whitened channel information comprising the channel information and the pre-whitening matrix. The pre-whitening matrix may comprise a pre-whitening filter reflecting at least one spatial direction or layer with lower interference and noise. The pre-whitening matrix may be obtained/determined by the covariance matrix based on a Cholesky factorization or based on an eigenvalue decomposition. Then, the network node may determine at least one of a precoder and a modulation and coding scheme according to the whitening information and the channel information. The network node may perform a downlink transmission to the UE by using the at least one of the precoder and the modulation and coding scheme.

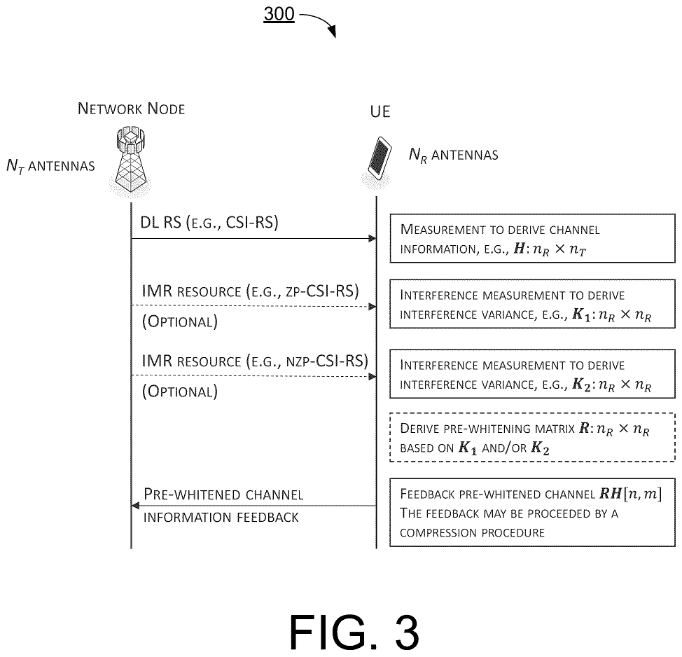

FIG. 3 illustrates an example scenario 300 under schemes in accordance with implementations of the present disclosure. Scenario 300 involves at least one UE and at least one network node, which may be a part of a wireless communication network (e.g., an LTE network, a 5G/NR network, an IoT network or a 6G network). Scenario 300 illustrates a novel channel information feedback scheme. A UE may connect to the network side. The network side may comprise one or more than one network nodes. The network node may transmit the DL RS (e.g., CSI-RS) to the UE via n_{T} antennas. The UE may acquire the channel information between itself and the network node by measuring the CSI-RS via n_{R} antennas. The UE may perform a measurement to derive the channel information (e.g., H:n_{R}×n_{T}).

In addition, the network node may further transmit an IMR to the UE. The IMR may comprise a ZP DL RS. The UE may perform an interference measurement to derive an interference variance (e.g., covariance matrix K₁:n_{R}×n_{R}). The network node may also transmit another IMR to the UE. The IMR may comprise an NZP DL RS. The UE may perform an interference measurement to derive an interference variance (e.g., covariance matrix K₂:n_{R}×n_{R}). After determining the interference variance, the UE may derive a pre-whitening matrix R:n_{R}×n_{R} based on at least one of K₁ and K₂. Then, the UE may determine a pre-whitened channel RH[n, m] based on the pre-whitening matrix and the channel information, and feedback the pre-whitened channel to the network side. The feedback may be proceeded by a compression procedure. After receiving the pre-whitened channel, the network side may be able to determine a proper/optimal precoder and/or modulation and coding scheme for the following communications.

In one novel aspect, the information/channel parameters to be fed back may be derived based on an equivalent channel (e.g., a pre-whitened channel). The equivalent channel may comprise the channel information and the whitening information. The pre-whitened channel may be defined as:

$${H}^{w} [ n , m ] = RH [ n , m ]$$

R denotes the pre-whitening matrix n_{R}×n_{R} (i.e., whitening information) which may be derived based on a covariance matrix K:n_{R}×n_{R} at the receiver side. H[n, m] denotes the channel information as stated above. The operations on extracting {Λ, Ω}, {Λ[n], Ω′} or {Λ[n, m], Ω″} may be applied on the pre-whitened channel as defined by H^{w}[n, m].

In some implementations, the covariance matrix may comprise a square matrix representing noise variance at receiver side. In some implementations, the covariance matrix may be measured from a (pre-)configured resource, e.g., IMR for interference measurement. The IMR may comprise a ZP DL RS and/or an NZP DL RS. The covariance matrix may be based on the measurement of both ZP DL RS and NZP DL RS. The covariance matrix may comprise colored noise matrix. In some implementations, the covariance matrix may be determined based on receiver's noise level in n_{R} receiver branches. The covariance matrix may comprise a white noise. In some implementations, the R matrix may be a matrix derived from Cholesky factorization (e.g., K=L^{H}L and R=L^{-H}).

Compression on the pre-whitened channel H^{w}[n, m]=RH[n, m] may follow the operations elaborated above for H[n, m]. In some implementations, the magnitude information may be preserved. For example, the linear combination coefficients in Λ (or Λ[n] or Λ[n, m]) may not be normalized based on the strongest coefficient, i.e., the strongest one is not magnitude 1. In some implementations, the magnitude information may not be preserved. For example, the linear combination coefficients in Λ (or Λ[n] or Λ[n, m]) may be normalized based on the strongest coefficient. The information on the strongest coefficient's magnitude may be additionally fed back to the receiver side.

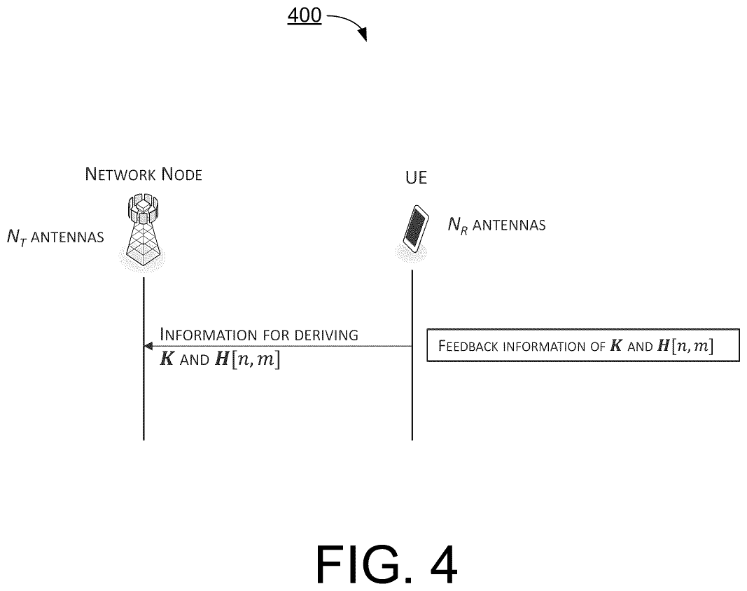

FIG. 4 illustrates an example scenario 400 under schemes in accordance with implementations of the present disclosure. Scenario 400 involves at least one UE and at least one network node, which may be a part of a wireless communication network (e.g., an LTE network, a 5G/NR network, an IoT network or a 6G network). Scenario 400 illustrates one novel aspect in channel information feedback scheme. In this embodiment, channel information H[n, m] and covariance matrix K may be reported/feedback individually by the UE. Specifically, the pre-whitened channel may be determined by H^{w}[n, m]=RH[n, m]. R may be derived from covariance matrix K as stated above. The feedback of H[n, m] may also follow similar procedure/operation as stated above. The UE may report K and H[n, m] individually in one report or in different reports to the receiver side. After receiving K and H[n, m], the network node may be able to derive R based on K and determine the pre-whitened channel by H^{w}[n, m]=RH[n, m]. The UE may not need to know the information about R. The pre-whitened channel may be derived at the network side.

In some implementations, the magnitude information of H[n, m] and K may be preserved individually. In some implementations, the relative magnitude information of H[n, m] and K may be preserved. The linear combination coefficients in Λ (or Λ[n] or Λ[n, m]) may be normalized based on the strongest coefficient. The entries in K may be normalized based on the strongest coefficient above. In some implementations, the covariance matrix K may be condensed to noise variance values. In one example, the covariance matrix K is white so that it is a diagonal matrix with a same noise variance value. Only the noise variance value is reported. In one example, the covariance matrix K is white so that it is a diagonal matrix with individual noise variance values. Only the noise variance values are reported. The noise variance values to be fed back may be normalized based on the strongest coefficient in Λ (or Λ[n] or Λ[n, m]).

In one novel aspect, the feedback of the pre-whitened channel RH[n, m] may be proceeded by a compression procedure. The pre-whitening matrix may comprise a pre-whitening filter reflecting at least one spatial direction or layer with lower interference and noise. In this case, the pre-whitening filter R may be incorporated into the channel and thus does not need to be reported separately. Specifically, the UE may perform the interference measurement to derive the covariance matrix K. Assuming that K is the covariance matrix of the spatially colored interference plus noise K=VΣV^{H}. V comprises eigen vectors and may reflect the spatial directions of interference and noise. Σ may reflect the magnitude. The UE may determine the pre-whitening filter as

$$R = {\sum }^{- \frac{1}{2}} {V}^{H} .$$

The compression operations may be carried out on the pre-whitened channel by

$$RH [ n , m ] = {\sum }^{- \frac{1}{2}} {V}^{H} Λ {Γ}_{Ω} [ n , m ] ,$$

instead of the physical channel H[n, m] been measured. Such process may be transparent to the network node. The interference plus noise term would then be normalized to an identity matrix, i.e., independent and identically distributed (i.i.d.) with unit variance across RX antennas. The feedback may include a scalar that scales the parameterized direct channel feedback of the pre-whitened channel (and thus the unit variance of the whitened interference plus noise term) properly to minimize quantization error.

The pre-whitening filter

$$R = {\sum }^{- \frac{1}{2}} {V}^{H}$$

implies that the spatial directions (or layers) in which interference plus noise variance is small (e.g., less than a threshold) will be scaled up as more transmission energy should be directed to such spatial directions (or layers) to maximize throughput, and the layers with strong interference plus noise variance will be scaled down. Accordingly, the feedback overhead may be further reduced, especially in channel where interference is highly colored.

In one novel aspect, the feedback of the pre-whitened channel H^{w}[n, m]=RH[n, m] may be proceeded by a compression procedure. The compression procedure of \tilde{H}^{w}[n, m] may include two steps. In the first step, the UE may project \tilde{H}^{w}[n, m] into eigen subspaces and selecting (eigen-)subspaces with strong projection values (e.g., greater than a threshold), and reconstruct a rank-reduced channel \tilde{H}^{W}[n, m] based on the selected (eigen-)subspaces. For example, the UE may perform eigenvalue decomposition to \tilde{H}^{w}[n, m] and selecting a subset of eigenvectors whose eigenvalues are the strongest ones, and construct \tilde{H}^{W}[n, m] based on the subset of eigenvectors and eigenvalues. The small or weak (eigen-)subspaces (e.g., less than a threshold) may be omitted from reporting to reduce the signaling overhead. In the second step, the UE may further perform compression of \tilde{H}^{W}[n, m] based on the compression schemes as stated above.

### Illustrative Implementations

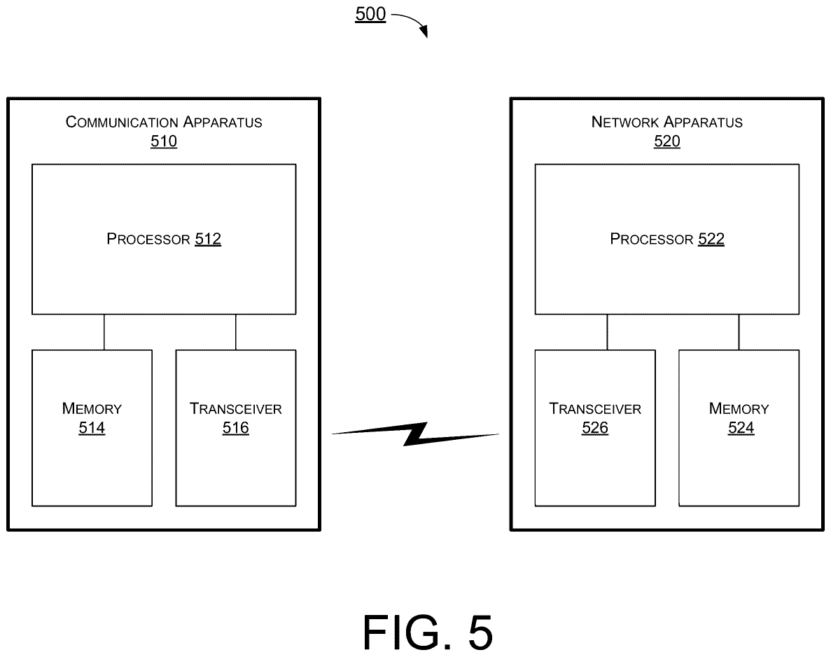

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to channel information feedback with whitening information with respect to user equipment and network apparatus in mobile communications, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 910 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a small cell, a router or a gateway. For instance, network apparatus 520 may be implemented in an eNodeB in an LTE network, in a gNB in a 5G/NR, IoT, NB-IoT or IIoT network or in a satellite or base station in a 6G network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including channel information feedback with whitening information in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, transceiver 516 may be capable of wirelessly communicating with different types of UEs and/or wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, network apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, communication apparatus 510 may further include a memory 514 coupled to processor 512 and capable of being accessed by processor 512 and storing data therein. In some implementations, network apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 510 and network apparatus 520 may be a communication entity capable of communicating with each other using various proposed schemes in accordance with the present disclosure. For illustrative purposes and without limitation, descriptions of capabilities of communication apparatus 510, as a UE, and network apparatus 520, as a network node (e.g., TRP), are provided below with processes 600 and 700.

### Illustrative Processes

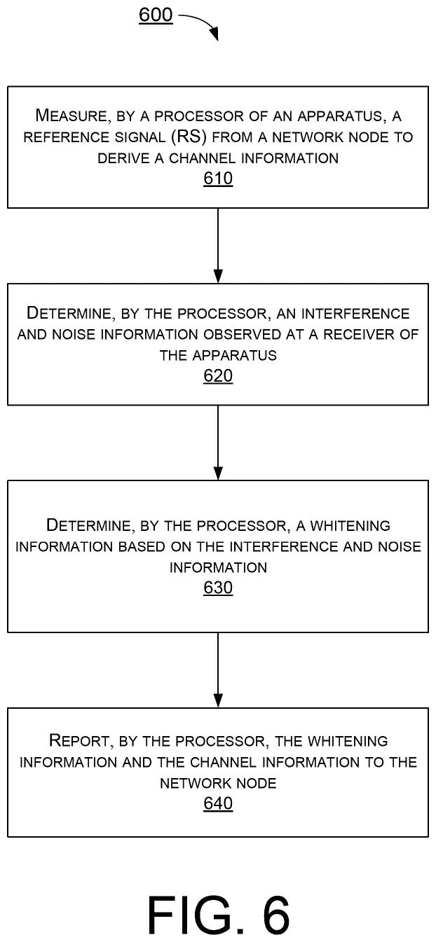

FIG. 6 illustrates an example process 600 in accordance with an implementation of the present disclosure. Process 600 may be an example implementation of above scenarios/schemes, whether partially or completely, with respect to channel information feedback with whitening information with the present disclosure. Process 600 may represent an aspect of implementation of features of communication apparatus 510. Process 600 may include one or more operations, actions, or functions as illustrated by one or more of blocks 610, 620, 630 and 640. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At block 610, process 600 may involve processor 512 of communication apparatus 510 measuring, via transceiver 516, a reference signal from a network node to derive a channel information. Process 600 may proceed from block 610 to block 620.

At block 620, process 600 may involve processor 512 determining an interference and noise information observed at receiver 516 of communication apparatus 510. Process 600 may proceed from block 620 to block 630.

At block 630, process 600 may involve processor 512 determining a whitening information based on the interference and noise information. Process 600 may proceed from block 630 to block 640.

At block 640, process 600 may involve processor 512 reporting, via transceiver 516, the whitening information and the channel information to the network node.

In some implementations, process 600 may further involve processor 512 determining a pre-whitening matrix based on a covariance matrix. The covariance matrix may comprise at least one of a square matrix representing noise variance at a receiver of the apparatus, a white noise, and a covariance matrix of spatially colored interference plus noise. Processor 512 may obtain/determine the pre-whitening matrix by the covariance matrix based on a Cholesky factorization or based on an eigenvalue decomposition.

In some implementations, process 600 may further involve processor 512 reporting, via transceiver 516, a pre-whitened channel information comprising the channel information and the pre-whitening matrix to the network node.

In some implementations, process 600 may further involve processor 512 reporting, via transceiver 516, the channel information and the covariance matrix individually to the network node.

In some implementations, process 600 may further involve processor 512 determining the covariance matrix by measuring an IMR. The IMR may comprises at least one of a ZP DL RS and an NZP DL RS.

In some implementations, the pre-whitening matrix may comprise a pre-whitening filter reflecting at least one spatial direction or layer with lower interference and noise.

In some implementations, the interference and noise information may comprise only an interference information or only a noise information.

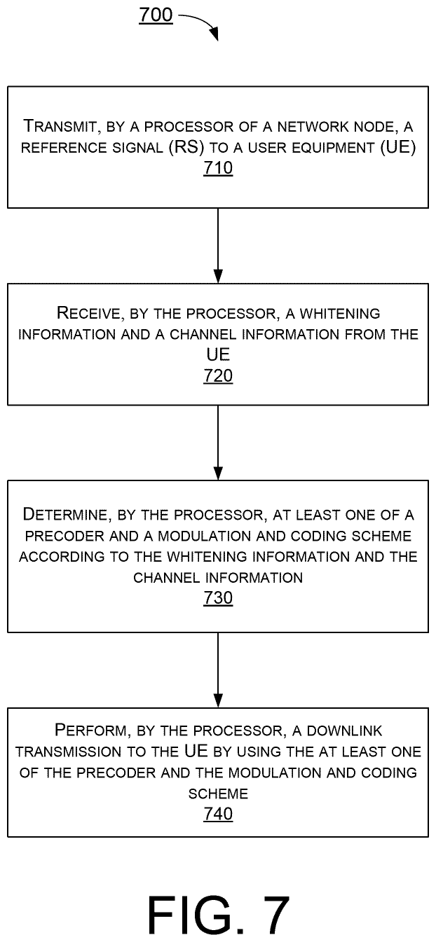

FIG. 7 illustrates an example process 700 in accordance with an implementation of the present disclosure. Process 700 may be an example implementation of above scenarios/schemes, whether partially or completely, with respect to channel information feedback with whitening information with the present disclosure. Process 700 may represent an aspect of implementation of features of network apparatus 520. Process 700 may include one or more operations, actions, or functions as illustrated by one or more of blocks 710, 720, 730 and 740. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by network apparatus 520 or any suitable base station or network nodes. Solely for illustrative purposes and without limitation, process 700 is described below in the context of network apparatus 520. Process 700 may begin at block 710.

At block 710, process 700 may involve processor 522 of network apparatus 520 transmitting, via transceiver 526, a reference signal to a UE. Process 700 may proceed from block 710 to block 720.

At block 720, process 700 may involve processor 522 receiving, via transceiver 526, a whitening information and a channel information from the UE. Process 700 may proceed from block 720 to block 730.

At block 730, process 700 may involve processor 522 determining at least one of a precoder and a modulation and coding scheme according to the whitening information and the channel information. Process 700 may proceed from block 730 to block 740.

At block 740, process 700 may involve processor 522 performing a downlink transmission to the UE by using the at least one of the precoder and the modulation and coding scheme.

In some implementations, the whitening information may comprise a pre-whitening matrix. The pre-whitening matrix may comprise a pre-whitening filter reflecting at least one spatial direction or layer with lower interference and noise.

In some implementations, process 700 may further involve processor 522 receiving, via transceiver 526, a pre-whitened channel information comprising the channel information and the pre-whitening matrix from the UE.

In some implementations, process 700 may further involve processor 522 receiving, via transceiver 526, the channel information and a covariance matrix individually from the UE.

In some implementations, process 700 may further involve processor 522 determining the pre-whitening matrix based on the covariance matrix. Processor 522 may obtain/determine the pre-whitening matrix by the covariance matrix based on a Cholesky factorization or based on an eigenvalue decomposition. Process 700 may further involve processor 522 determining a pre-whitened channel information comprising the channel information and the pre-whitening matrix.

In some implementations, process 700 may further involve processor 522 transmitting, via transceiver 526, an IMR to the UE. The IMR may comprise at least one of a ZP DL RS and an NZP DL RS.

In some implementations, the whitening information may comprise only an interference information or only a noise information.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
measuring, by a processor of an apparatus, a reference signal (RS) from a network node to derive a channel information;
determining, by the processor, an interference and noise information observed at a receiver of the apparatus;
determining, by the processor, a whitening information based on the interference and noise information; and
reporting, by the processor, the whitening information and the channel information to the network node.

2. The method of claim 1, wherein the determining of the whitening information further comprises:
determining, by the processor, a pre-whitening matrix based on a covariance matrix.

3. The method of claim 2, wherein the pre-whitening matrix is obtained by the covariance matrix based on a Cholesky factorization or based on an eigenvalue decomposition.

4. The method of claim 2, wherein the reporting of the whitening information and the interference and noise information further comprises:
reporting, by the processor, a pre-whitened channel information comprising the channel information and the pre-whitening matrix to the network node.

5. The method of claim 2, wherein the reporting of the whitening information and the interference and noise information further comprises:
reporting, by the processor, the channel information and the covariance matrix individually to the network node.

6. The method of claim 2, further comprising:
determining, by the processor, the covariance matrix by measuring an interference measurement resource (IMR),
wherein the IMR comprises at least one of a zero-power (ZP) downlink (DL) RS and a non-zero-power (NZP) DL RS.

7. The method of claim 2, wherein the pre-whitening matrix comprises a pre-whitening filter reflecting at least one spatial direction or layer with lower interference and noise.

8. The method of claim 1, wherein the interference and noise information comprises only an interference information or only a noise information.

9. A method, comprising:
transmitting, by a processor of a network node, a reference signal (RS) to a user equipment (UE);
receiving, by the processor, a whitening information and a channel information from the UE;
determining, by the processor, at least one of a precoder and a modulation and coding scheme according to the whitening information and the channel information; and
performing, by the processor, a downlink transmission to the UE by using the at least one of the precoder and the modulation and coding scheme.

10. The method of claim 9, wherein the whitening information comprises a pre-whitening matrix.

11. The method of claim 10, wherein the pre-whitening matrix comprises a pre-whitening filter reflecting at least one spatial direction or layer with lower interference and noise.

12. The method of claim 10, wherein the receiving of the whitening information and the channel information further comprises:
receiving, by the processor, a pre-whitened channel information comprising the channel information and the pre-whitening matrix from the UE.

13. The method of claim 10, wherein the receiving of the whitening information and the channel information further comprises:
receiving, by the processor, the channel information and a covariance matrix individually from the UE.

14. The method of claim 13, further comprising:
determining, by the processor, the pre-whitening matrix based on the covariance matrix; and
determining, by the processor, a pre-whitened channel information comprising the channel information and the pre-whitening matrix.

15. The method of claim 9, further comprising:
transmitting, by the processor, an interference measurement resource (IMR) to the UE,
wherein the IMR comprises at least one of a zero-power (ZP) downlink (DL) RS and a non-zero-power (NZP) DL RS.

16. The method of claim 9, wherein the whitening information comprises only an interference information or only a noise information.

17. An apparatus, comprising:
a transceiver which, during operation, wirelessly communicates with at least one network node; and
a processor communicatively coupled to the transceiver such that, during operation, the processor performs operations comprising:
measuring, via the transceiver, a reference signal (RS) from a network node to derive a channel information;
determining an interference and noise information observed at a receiver of the apparatus;
determining a whitening information based on the interference and noise information; and
reporting, via the transceiver, the whitening information and the channel information to the network node.

18. The apparatus of claim 17, wherein, in determining the whitening information, the processor further performs operations comprising:
determining a pre-whitening matrix based on a covariance matrix.

19. The apparatus of claim 18, wherein, in reporting the whitening information and the interference and noise information, the processor further performs operations comprising:
reporting, via the transceiver, a pre-whitened channel information comprising the channel information and the pre-whitening matrix to the network node.

20. The apparatus of claim 18, wherein, in reporting the whitening information and the interference and noise information, the processor further performs operations comprising:
reporting, via the transceiver, the channel information and the covariance matrix individually to the network node.
